(19) United States
(12) Patent Application Publication
(10) Pub. No.: US 2008/0261180 A1
(43) Pub. Date: Oct. 23, 2008

(54) Dental hand signaling system and method

(76) Inventor: Raymond Martin Cadden, Plantation, FL (US)

Correspondence Address: RAYMOND CADDEN, 7381 SW 18TH ST, PLANTATION, FL, 33317, US

(21) Appl. No.: 11/788,020

(22) Filed: Apr. 19, 2007

(51) Int. Cl. G09B 21/00

(52) U.S. Cl. 434/156

(57) ABSTRACT

A hand signaling system and method provides a series of hand gestures for enabling non-verbal communication from a patient to a dental practitioner during a dental procedure. The system and method enable reduced procedure time.

### BACKGROUND OF THE INVENTION

1. Field of the Invention

The present invention relates generally to non-verbal signaling. More specifically, the invention relates to a hand signaling system and method particularly well suited for non-verbal communication between a dental patient and a dental practitioner.

2. Description of the Prior Art

The importance of dental care has been clearly established. When one considers that an estimated. 75% of Americans suffer from some form of periodontal disease and that tooth decay is 5 times more common that asthma and 7 times more common than hay fever in children, it is no wonder that there is an increasing awareness and need for dental health care.

Increasing attention to dental hygiene and maintenance, however, has also resulted in other concerns for patients. Because of the invasive nature of most dental procedures, patients find themselves at a disadvantage in engaging in a dialogue with health care providers. Since their ability to speak is impaired during dental visits, patients are restricted to vague hand gestures, indecipherable grunts, and questionable sounds when answering questions directed at them by the dental professional, or when attempting to communicate a message to the practitioner.

This inability to communicate can result in a very frustrating and uncomfortable experience for the patient, which, in turn, can lead to avoidance of dental procedures altogether. This is detrimental to the patient, who will not receive the proper dental care, increasing the likelihood of more serious periodontal conditions. The loss of patients is in turn detrimental to the dental professional's business.

Another issue that can have a negative impact is the amount of additional time that it takes when ineffective communication exists between doctor and patient. Procedures are unnecessarily prolonged by frequent interruptions as the dentist tries to extract information from patients, resulting in an additional loss of time by the patients who are undergoing the procedure, increased wait time for patients who are awaiting to undergo a procedure, as well as increased stress on dentists, who must alter their schedules to compensate for the time discrepancies in scheduling.

Accordingly, there is an established need for a dental hand signal method that, in addition to having the ability to be efficiently mastered, can also be displayed in various multi-media formats accessible to patients and dentists alike, resulting in a decreases amount of communication time needed during the performance of dental procedures.

### SUMMARY OF THE INVENTION

The present invention is directed to a dental hand signal method. The dental hand signal method of the present invention is designed for practical display, enabling patients and dentists to quickly learn each communicative hand gesture, shortening the time for procedures and increasing control by patients over the dental procedure experience.

It is an object of the present invention is to provide a dental hand signal system that can be quickly and effectively learned for immediate use in a dental environment.

It is another object of the present invention is to provide such a system that affords the user with an adequate variety of commands to enable effective and efficient non-verbal communication from a dental patient to a dental practitioner.

It is a further object of the present invention is to provide such a system and method that decreases the number of interruptions during a dental procedure, by streamlining communication between doctor and patient

In accordance with a general aspect of the invention, a dental hand signal method is provided that utilizes a series of hand gestures that communicate specific directives from a patient to a dentist, while the patient is unable to communicate verbally.

In accordance with a further aspect of the invention, the dental hand signal system is designed in a manner facilitating visual display in a variety of multimedia formats, such as posters, display monitors, projection screens, manuals and the like.

In accordance with a further aspect of the invention, the dental hand signal system does not require extensive training by either doctor or patient

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawing Figures, provided to illustrate and not to limit the invention, and in which:

FIG. 1 illustrates a hand signal indicating that the patient wishes the dentist to at least temporarily stop or terminate the procedure;

FIG. 2 illustrates a hand signal indicating that the patient is okay;

FIG. 3 illustrates a hand signal indicating that the patient is suffering from nerve pain;

FIG. 4 illustrates a hand signal indicating that the patient needs to scratch his or her face;

FIG. 5 illustrates a hand signal indicating that the patient wishes to speak with the dentist;

FIG. 6 illustrates a hand signal indicating that the patient wishes to rinse his or her mouth;

FIG. 7 illustrates a hand signal indicating that the patient is hurting a little; and

FIG. 8 illustrates a hand signal indicating that the patient is hurting a lot.

### DETAILED DESCRIPTION OF THE PREFERRED EMBODIMENTS

Shown throughout the Figures, the present invention is generally directed to a dental hand signal system offering a practical substitute to typical verbal communication, particularly for dental patients whose speech is hindered during a dental procedure restrict use of the mouth. The dental hand signal system establishes a standard communication approach between dentist and patient that can be learned in a time efficient manner and displayed through a variety of multimedia formats, reducing the amount of time required for a dental procedure and providing patients with more control during the procedure.

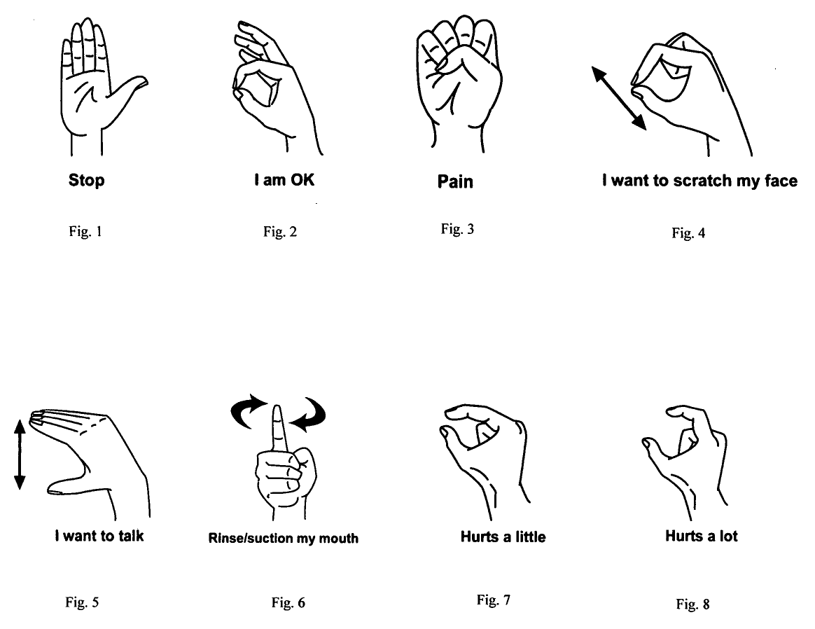

Referring to FIG. 1, a first hand gesture is shown indicating that the patient desires that the doctor terminate, or temporarily stop, a procedure. This hand gesture is accomplished by having the palm face outwards, while the index finger, middle finger, ring finger, and pinky are held together, separated from the thumb.

Referring to FIG. 2, a second hand gesture is shown indicating that the patient is okay. This hand gesture would typically be provided in response to a verbal inquiry from the dental practitioner. This hand gesture is accomplished by bringing the tip of the index finger into contact with the tip of the thumb, forming an “O”, with the remaining fingers pressed together and pointing upwardly.

Referring to FIG. 3, a third hand gesture is shown indicating the patient is suffering from nerve pain. This gesture is accomplished by having the index finger, middle finger, ring finger, and pinky all curled in toward the palm, with the thumb pressing against the index and middle fingers, much like making a forward facing fist.

Referring now to FIG. 4, a fourth hand gesture is shown indicating the patient desires to scratch his or her face. This gesture is accomplished by touching the tip of the index finger with the end of the thumb, while maintaining the middle finger, ring finger, and pinky curled inward toward the palm, and then rubbing the tip of the index finger back-and-forth along the inner surface of the thumb.

Referring now to FIG. 5, a fifth hand gesture is shown indicating the patient desires to speak with the practitioner. This gesture is accomplished by joining the index finger, middle finger, ring finger and pinky to form a “C” shape, with the tips of the aforementioned fingers maintained slightly spaced apart from the thumb, and then alternating between engagement and separation of the tips of the fingers and the end of the thumb.

Referring now to FIG. 6, a sixth hand gesture is shown indicating the patient desire to rinse his or her mouth. This gesture is accomplished by curling the middle finger, the ring finger, and the pinky in towards the palm, forming a partial fist, with the thumb pressed against the middle finger, and then repeatedly moving the extended index finger in a circular, or rotating, motion.

Referring now to FIG. 7, a seventh hand gesture is shown indicating the patient is feeling slight pain or discomfort This gesture is accomplished by curling the middle finger, the ring finger and the pinky, toward the palm, and bringing the tip of the extended index finger into a position slightly spaced apart from the tip of the extended thumb.

Referring now to FIG. 8, an eighth hand gesture is shown indicating the patient is feeling significant discomfort or pain. This gesture is accomplished by orienting the hand and fingers as shown in FIG. 7, but with the tip of the extended index finger positioned in a more spaced apart position from the extended thumb.

The unique combination of hand gestures provides a method for enabling non-verbal communication directed from a patient to a dental practitioner during a dental procedure. The number and variations of the hand gestures are limited such that they can be efficiently and effectively learned by a patient and a practitioner in a matter of minutes. Furthermore, the hand gestures can be provided in any of a number of convenient formats displayable within a typical dental environment.

Since many modifications, variations, and changes in detail can be made to the described preferred embodiments of the invention, it is intended that all matters in the foregoing description and shown in the accompanying drawings be interpreted as illustrative and not in a limiting sense. For instance, as will be apparent to those skilled in the art, subtle variations of the hand gestures of the present invention may be possible without departing from the scope of the invention. Furthermore, alternate embodiments particularly geared toward use with young children are contemplated, in which minor modifications of the hand signals may be provided which are easier for children to comprehend and learn. Furthermore, pictoral images may be provided, particularly for use with younger dental patients, wherein the hand signals are combined with cartoon or other characters, to make them more kid friendly.

What is claimed is:

1. A dental hand signal system comprising:
a series of hand gestures formed by variations in the positioning of the palm and digits of a single hand of a patient to enable the patient to immediately convey specific needs or concerns to a dental practitioner during a dental procedure.

2. A dental hand signal system as recited in claim 1, further comprising multimedia means for displaying the series of hand gestures for quick and easy reference by a dental patient during a dental procedure.
